(19) United States
(12) Patent Application Publication
(10) Pub. No.: US 2006/0285043 A1
(43) Pub. Date: Dec. 21, 2006

(54) Display device and portable display apparatus having the same

(76) Inventors: Sung-min Kim, Yongin-si (KR); Young-bee Chu, Suwon-si (KR); Byung-woong Han, Incheon Metropolitan City (KR); Jeung-soo Kim, Seoul (KR); Jong-nam Lee, Anyang-si (KR); Chang-hyeon Shin, Seongnami-si (KR); Dong-ho Lee, Yongin-si (KR)

Correspondence Address: F. CHAU & ASSOCIATES, LLC, 130 WOODBURY ROAD, WOODBURY, NY, 11797, US

(21) Appl. No.: 11/442,671

(22) Filed: May 26, 2006

Related U.S. Application Data
(63) Continuation-in-part of application No. 11/329,720, filed on Jan. 11, 2006.

(30) Foreign Application Priority Data
May 26, 2005 (KR) 10-2005-0044616
Apr. 27, 2006 (KR) 10-2006-0038064

(51) Int. Cl. G02F 1/1333

(52) U.S. Cl. 349/122

(57) ABSTRACT

A display device includes a display panel having a first substrate and a second substrate opposite to the first substrate; a transparent film formed on the second substrate; and a buffer layer formed between the second substrate and the transparent film.

This application claims priority from Korean Patent Application Nos. 10-2005-0044616 filed on May 26, 2005 and 10-2006-0038064 filed on Apr. 27, 2006, the disclosures of which are hereby incorporated by reference herein in their entirety.

### BACKGROUND OF THE INVENTION

1.

Technical Field

The disclosure relates to a display device and a portable display apparatus having the same and, more particularly, to a display device which is thin and lightweight and a portable display apparatus having the same.

2. Description of the Related Art

Due to the demand for thinner and more lightweight display apparatuses (e.g. monitors or television sets), cathode ray tubes (CRTs) are now being replaced with flat panel displays (FPDs).

A conventional flat panel display may include, for example, a liquid crystal display (LCD) device including a first substrate having thin film transistors (TFTs) formed thereon, a second substrate having color filter layers formed thereon, a liquid crystal layer interposed between the first substrate and the second substrate, and an organic light emitting diode (OLED) display device including TFTs and organic light emitting elements.

The flat panel displays may be used in conjunction with various portable display apparatuses for displaying images, such as, for example, cellular phones, notebook computers, and personal digital assistances (PDAs).

For example, a conventional portable display apparatus may include a predetermined frame to support the flat panel display and a case which houses the frame and which has an opening through which a viewer can see an image displayed by the display device. In addition, conventional portable display apparatuses typically have a protective window made of a material, such as, for example, transparent glass, for protecting the display device that is exposed through the opening of the case.

However, a difficulty with conventional portable display apparatuses is that the protective window is formed of, for example, glass or plastic, which increases the overall thickness and weight of these apparatuses. In addition, the glass or plastic protective window of these conventional portable display apparatus is also readily susceptible to breakage due to an external impact. Consequently, to protect the display device from an external impact, an air layer has been developed for placement between the display device and the protective window. However, the above-mentioned air layer may cause the overall thickness of the portable display apparatus to further increase.

Thus, there is a need for a display device which is both thin and lightweight and for a portable display apparatus having the same.

### SUMMARY OF THE INVENTION

According to an exemplary embodiment of the invention, a display device is provided. The display device includes a display panel provided with a first substrate and a second substrate opposite to the first substrate, a transparent film formed on the second substrate and a buffer layer formed between the transparent film and the second substrate.

According to an exemplary embodiment of the invention, a display device is provided. The display device includes a liquid crystal panel module having first and second liquid crystal panels each provided with a first substrate, a second substrate, and a liquid crystal layer interposed between the first substrate and the second substrate. The first substrate of each of the first and second liquid crystal panels are disposed opposite to each other. The display device further includes a transparent film formed on the second substrate of each of the first and second liquid crystal panels of the liquid crystal panel module and a buffer layer formed between the transparent film and the second substrate of each of the first and second liquid crystal panels.

According to another exemplary embodiment of the invention, a portable display apparatus is provided. The portable display apparatus includes a liquid crystal display device having a liquid crystal panel provided with a first substrate, a second substrate, and a liquid crystal layer interposed between the first substrate and the second substrate. The portable display apparatus further includes a transparent film formed on the second substrate, a frame supporting the liquid crystal display device housed therein and a case housing the frame.

According to an exemplary embodiment of the invention, a portable display apparatus is provided. The portable display apparatus includes a liquid crystal panel module having first and second liquid crystal panels each provided with a first substrate, a second substrate, and a liquid crystal layer interposed between the first substrate and the second substrate. The first substrate of each of the first and second liquid crystal panels are disposed opposite to each other. The portable display apparatus further includes a transparent film formed on the second substrate of each of the first and second liquid crystal panels of the liquid crystal panel module, a frame supporting the liquid crystal panel module housed therein and a case housing the frame,

According to an exemplary embodiment of the invention, a display device is provided. The display device includes a display panel, and a transparent film formed on the display panel. The display device further includes an adhesive buffer layer, formed between the display panel and the transparent film, and having a transmittance of at least about 60%.

According to another exemplary embodiment of the invention, a display device is provided. The display device includes a display panel and a transparent film formed on the display panel. The display device further includes a buffer layer, formed between the display panel and the transparent film. Moreover, the buffer layer includes at least two distinct layers.

### BRIEF DESCRIPTION OF THE DRAWINGS

Exemplary embodiments of the present invention can be understood in more detail from the following description taken in conjunction with the attached drawings in which:

FIGS. 1A and 1B are cross-sectional views illustrating a liquid crystal display device according to an exemplary embodiment of the invention;

FIG. 2 is a cross-sectional view illustrating a liquid crystal display device according to an exemplary embodiment of the invention;

FIGS. 3 and 4 are perspective views illustrating a liquid crystal display device according to an exemplary embodiment of the invention;

FIGS. 5 to 8 are cross-sectional views illustrating a liquid crystal display device according to an exemplary embodiment of the invention;

FIG. 9 is a perspective view illustrating a portable display apparatus according to an exemplary embodiment of the invention;

FIG. 10 and 11 is a longitudinal cross-sectional view of a region A shown in FIG. 9;

FIG. 12 is a perspective view illustrating a portable display apparatus according to an exemplary embodiment of the invention;

FIG. 13 and 14 is a longitudinal cross-sectional view of a region B shown in FIG. 12; and

### DETAILED DESCRIPTION OF THE EXEMPLARY EMBODIEMENTS

The present invention may be embodied in many different forms and should not be construed as being limited to the exemplary embodiments set forth herein. Like reference numerals refer to like elements throughout the specification.

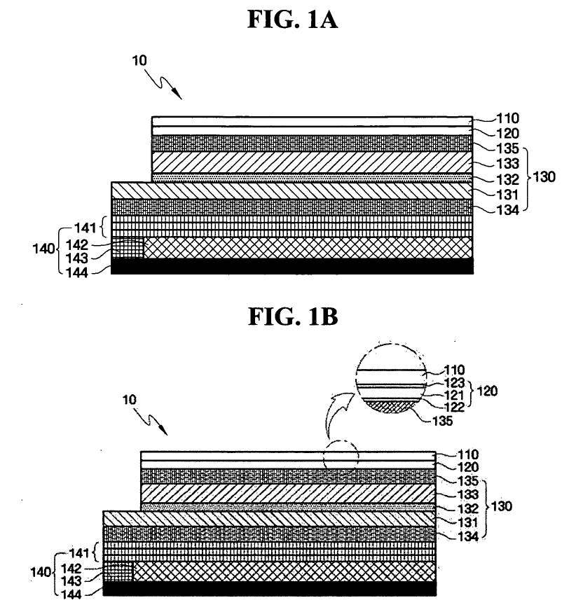

Hereinafter, a liquid crystal display device according to a first exemplary embodiment of the present invention will be described with reference to FIGS. 1A and 1B. FIGS. 1A and 1B are cross-sectional views of a liquid crystal display device 10 according to the first exemplary embodiment of the invention.

Referring to FIGS. 1A and 1B, the liquid crystal display device 10 includes a transparent film 110, a buffer layer 120, a liquid crystal panel 130, and a backlight unit 140.

In this exemplary embodiment, when mounting the components of the above-mentioned liquid crystal display 10 to apparatuses for displaying images, such as, for example, a portable display apparatus and an LCD monitor, these components may supported by a plurality of frames, such as, for example, a mold frame and a metal frame and may also be encased within an external case.

The transparent film 110 serves as a layer for protecting the liquid crystal panel 130 from chemicals and for preventing the liquid crystal panel 130 from being scratched. The transparent film 110 is formed of a material having scratch resistance and chemical resistance. The transparent film 110 should have sufficient transparency, for example a transmittance of at least about 90%, such that a viewer is able to sufficiently view an image displayed by the liquid crystal panel 130. Therefore, the transparent film 110 may be formed of a high polymer film satisfying the above-mentioned characteristic, such as, for example, polyethylene terephthalate (PET), polycarbonate (PC), or polymethylmethacrylate (PMMA). In this case, the transparent film 110 is formed with a thickness of about 0.2 centimeters (cm) to about 0.8 cm, but the thickness of the transparent film 110 is not limited to the above-mentioned range.

The buffer layer 120 is formed below the transparent film 110. The buffer layer 120 functions to absorb an external impact and to fix the transparent film 110 to the surface of the liquid crystal panel 130. The buffer layer 120 should be formed of a material which is not significantly affected by temperature to provide sufficient buffer characteristics. When the buffer layer 120 is formed of a material having a high degree of hardness at a low temperature, the buffer layer 120 may become damaged, and thus may not sufficiently perform the function of absorbing an external impact. In addition, the buffer layer 120 should be formed of a material having desirable adhesive characteristics with respect to both the transparent film 110 and the liquid crystal panel 130, such that the transparent film 110 may be fixedly attached to the liquid crystal panel 130. Further, the buffer layer 120 should have sufficient transparency, for example a transmittance of at least about 90%, such that a viewer is able to sufficiently view an image displayed by the liquid crystal panel 130. Therefore, the buffer layer 120 may be formed of a material satisfying the above-mentioned characteristics, such as, for example, a silicon resin or an acrylic resin. For example, OPT001-60 manufactured by GELTEC Co, Ltd. may be used as the silicon resin, and CLEAR FIT manufactured by Mitsubishi Chemical Corporation or OCA (optical clear adhesive) manufactured by 3M Korea Ltd., may be used as the acrylic resin. In this case, the buffer layer 120 may be formed with a thickness of about 0.4 cm to about 0.5 cm, but the thickness of the buffer layer 120 is not limited thereto. As described above, the buffer layer 120 in this exemplary embodiment, performs a buffer function and an adhesive function, which makes it possible to reduce the thickness of a liquid crystal display device.

As shown in FIG. 1B, the buffer layer 120 may be formed in a multi-layer structure of a first adhesive layer 122 adhered to the transparent film 110, a second adhesive layer 123 adhered to the liquid crystal panel 130, and a cushion layer 121 interposed between the first adhesive layer 122 and the second adhesive layer 123.

The liquid crystal panel 130 is arranged below the buffer layer 120 and includes a first substrate 131, a liquid crystal layer 132, a second substrate 133, a first polarizing plate 134, and a second polarizing plate 135.

The first substrate 131 is formed by providing a thin film transistor array and pixel electrodes on a glass substrate. The thin film transistor array is used as a switching element for applying a voltage to the pixel electrodes. The second substrate 133 is a glass substrate having color filter layers for displaying red (R), green (G), and blue (B) provided thereon. A common electrode is formed on the entire surface of the second substrate 133, and the common electrode formed on the color filter layers serves an electrode for applying a voltage to the liquid crystal. In addition, the common electrode forms an electric field together with the pixel electrodes formed on the first substrate 131. The liquid crystal layer 132 is interposed between the first substrate 131 and the second substrate 133, thereby forming the liquid crystal display device 10. The first and second polarizing plates 134 and 135 are mounted to the outer surfaces of the first and second substrates 131 and 133, respectively, and linearly polarize visible rays.

The backlight unit 140 is arranged below the liquid crystal panel 130 to emit light to the liquid crystal panel 130, and includes an optical sheet 141, an light guide panel 142, a light source 143, and a reflective sheet 144.

The optical sheet 141 is formed below the liquid crystal panel 130 and includes, for example, a prism sheet and a diffuser sheet. The diffuser sheet is positioned in a light emission part on the light guide panel 142 and diffuses and scatters incident light through the light guide panel 142. In addition, the diffuser sheet increases the brightness of and provides a uniform brightness for light emitted in the orthogonal direction to the front surface of the backlight unit 140. The prism sheet has a plurality of grooves formed therein and prevents the light emitted from the diffuser sheet from traveling in directions other than the orthogonal direction to the front surface of the backlight unit 140, thereby improving the directivity of the light emitted. As a result, the brightness of light emitted in the orthogonal direction to the front surface of the backlight unit 140 is improved. Two types of prism sheets, for example, a vertical-type prism sheet and a horizontal-type prism sheet, may be used for the backlight unit 140.

The light guide panel 142 converts linear light emitted from the light source 143 into surface light, and may be formed of an acrylic resin, such as, for example, polymethylmethacrylate (PMMA). In addition, various types of optical waveguides may be used for the backlight unit 140.

The light source 143 is a light emitting member, such as a light bulb, a light emitting diode (LED), a fluorescent lamp, an electroluminescent (EL) element, or a metal halide lamp. The light sources 143 may classified, for example, as either an edge-type light source or a direct-type light source according to the position where the light source is formed. In addition, various types of light sources may be used according to the type of liquid crystal display device being used.

The reflective sheet 144 is provided below the light guide panel 142, and reflects light emitted from the light source 143 in the orthogonal direction to the light emission surface of the backlight unit 140, thereby improving the light usage efficiency. In addition, the reflective sheet 144 adjusts the amount of reflected light with respect to incident light such that the entire light emission surface of the light source 143 uniformly distributes brightness.

As described above, because conventional liquid crystal display devices utilize protective windows which include a transparent glass or plastic material, these protective windows are susceptible to breakage or scratches from an external impact and thus as a result may require additional adhesive and buffer structures to be provided on a display portion of a liquid crystal panel to prevent the above damage to the protective window from occurring. Nevertheless, these additional adhesive and buffer structures, may result in an increase in the thickness and weight of the liquid crystal display device. However, in the liquid crystal display device according to the present exemplary embodiment of the invention, the transparent film is formed on the liquid crystal panel with the buffer layer interposed therebetween to protect the liquid crystal panel. Therefore, the liquid crystal display device according to this embodiment of the invention includes a transparent film which is light in weight and has a high scratch resistance, and uses a buffer layer having multi-functions without using additional adhesive and buffer structures, thereby providing a liquid crystal display device with a reduced thickness and weight in comparison to conventional liquid crystal display devices.

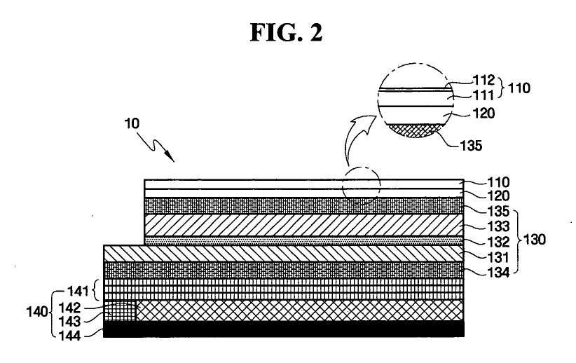

Hereinafter, a liquid crystal display device according to a second exemplary embodiment of the present invention will be described with reference to FIG. 2. FIG. 2 is a cross-sectional view of a liquid crystal display device 10 according to the second embodiment of the invention.

The liquid crystal display device 10 according to this exemplary embodiment of the invention is similar to the liquid crystal display device 10 (see FIGS. 1A) according to the first exemplary embodiment except that in the present exemplary embodiment a transparent film further includes a hard coating layer 112. Therefore, a description of components other than the transparent film 110 will be omitted for the purpose of simplicity of explanation.

Referring to FIG. 2, the transparent film 110 of the liquid crystal display device 10 according to the present exemplary embodiment of the invention serves as a layer for protecting the liquid crystal panel 130 from chemicals and for preventing the liquid crystal panel 130 from being scratched. The transparent film 110 should be formed of a material having a high scratch resistance and chemical resistance. The transparent film 110 should have sufficient transparency, for example, a transmittance of at least 90%, such that a viewer is able tosufficiently view an image displayed by the liquid crystal panel 130. Therefore, the transparent film 110 may be formed in a laminated structure of a polymer film 111 satisfying the above-mentioned characteristics and the hard coating layer 112 may be formed on the polymer film 111. The polymer film may be formed of, for example, polyethylene terephthalate (PET), polycarbonate (PC), or polymethylmethacrylate (PMMA). The hard coating layer 112 may be formed of, for example, a photosensitive resin, such as an ultraviolet photosensitive resin. In this case, the hard coating layer 112 has a hardness of about 3 H to about 4 H.

As described above, in the liquid crystal display device 10 according to the present exemplary embodiment of the invention, the transparent film 10 formed on the liquid crystal panel 130 includes the polymer film 111 and the hard coating layer 112. Consequently, the transparent film 10 has a higher durability and chemical resistance than a transparent film composed of only the polymer film 111. Thus, by including the hard coating layer 112 with the liquid crystal device 10, the liquid crystal panel 130 may be protected from scratches and chemicals.

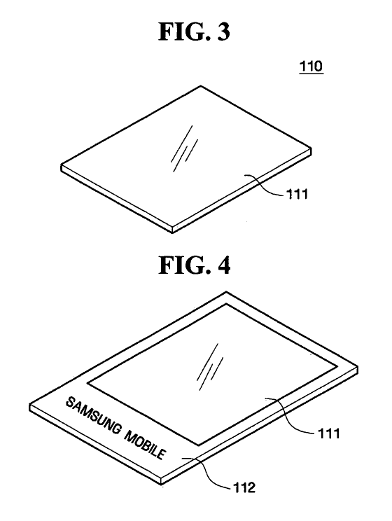

Hereinafter, a liquid crystal display device according to a third exemplary embodiment of the present invention will be described below with reference to FIGS. 1, 3, and 4. FIGS. 3 and 4 are perspective views illustrating a transparent film of a liquid crystal display device 10 according to the third embodiment of the invention.

The liquid crystal display device 10 according to this exemplary embodiment of the invention is similar to the liquid crystal display device 10 according to the first exemplary embodiment except in the present embodiment, a transparent film 110 is composed of a transmissive portion 111 which transmits light or the transparent film 110 is composed of the transmissive portion 111 and a light-shielding portion 112 which does not transmit light. Therefore, a description of components other than the transparent film 110 will be omitted for the purpose of simplicity of explanation.

Referring to FIG. 3, the transparent film 110 of the liquid crystal display device 10 according to the present exemplary embodiment of the invention serves as a layer for protecting the liquid crystal panel 130 from chemicals and for preventing the liquid crystal panel 130 from being scratched. The transparent film 110 should be formed of a material having high scratch resistance and chemical resistance. The transparent film 110 should have sufficient transparency such that a viewer is able to sufficiently view an image displayed by the liquid crystal panel 130.

In this case, the transparent film 110 may be composed of the transmissive portion 111 which transmits light, as shown in FIG. 3, or the transparent film 110 may be composed of the transmissive portion 111 which transmits light through the entire surface thereof and the light-shielding portion 112 which does not transmit light, as shown in FIG. 4.

The buffer layer 120 is formed below the transparent film 110 and functions to absorb an external impact and to fix the transparent film 110 to the surface of the liquid crystal panel 130. The buffer layer 120 should be formed of a material which is not significantly affected by temperature to provide sufficient buffer characteristics. For example, when the buffer layer 120 is formed of a material having a high degree of hardness at a low temperature, the buffer layer 120 may become damaged, and may not sufficiently perform the function of absorbing an external impact. In addition, the buffer layer 120 should have sufficient transparency such that a viewer is able to sufficiently view an image displayed by the liquid crystal panel 130.

Meanwhile, the buffer layer 120 may be omitted, and the transparent film 110 may be formed of an elastic material. In this case, the transparent film 110 comes into a direct contact with the liquid crystal panel 130. At that time, it is preferable to deflate a space between the transparent film 110 and the liquid crystal panel 130. Therefore, contact surfaces of the transparent film 110 and the liquid crystal panel 130 are electrified with reverse polarities, that is, negative and positive polarities, by static electricity, which enables the transparent film 110 and the liquid crystal panel 130 to be adhered to each other by electrostatic attraction.

As described above, according to the present embodiment of the invention, a thin and lightweight liquid crystal display device having high resistance to an external impact may be obtained.

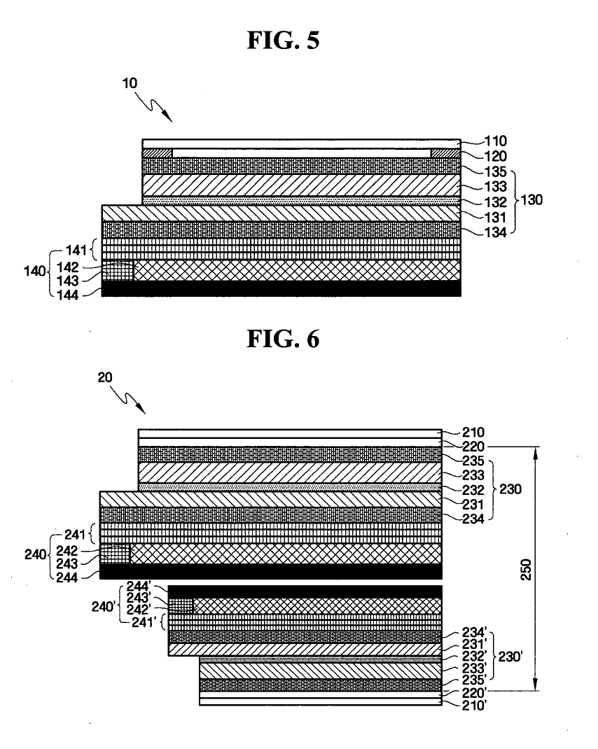

Next, a liquid crystal display device according to a fourth exemplary embodiment of the invention will be described with reference to FIGS. 3, 4, and 5. FIG. 5 is a cross-sectional view illustrating the liquid crystal display device 10 according to the fourth exemplary embodiment of the invention.

The liquid crystal display device 10 of this embodiment of the invention is similar to the liquid crystal display device 10 according to the first embodiment except that in the present exemplary embodiment, a buffer layer 120 is formed below a portion of a transparent film 110. Thus, in the present exemplary embodiment, the same components as those in the first embodiment will not be described for the purpose of simplicity of explanation.

Referring to FIG. 5, the liquid crystal display device includes the transparent film 110, the buffer layer 120 formed below a portion of the transparent film 110, a liquid crystal panel 130, and a backlight unit 140.

As shown in FIG. 3, the entire transparent film 110 is composed of a transmissive portion 111, and the buffer layer 120 is formed below a portion of the transmissive portion 111.

As shown in FIG. 4, when the transparent film 110 is composed of the transmissive portion 111 and the light-shielding portion 112, the buffer layer 120 may be formed below a portion of the transmissive portion 111 or the light-shielding portion 112 of the transparent film 110. Alternatively, the buffer layer 120 may be formed below a portion of the transmissive portion 111 and a portion of the light-shielding portion 112 of the transparent film 110.

In this case, materials other than the buffer layer, such as an air layer, may be provided in a space between the transparent film 110 and the second substrate 133 of the liquid crystal panel where the buffer layer 120 is not formed.

As shown in FIG. 1, the transparent film 110 may be directly bonded to the liquid crystal panel 130 without the buffer layer 120 interposed therebetween.

As described in the third exemplary embodiment, the transparent film 110 serves as a layer for protecting the liquid crystal panel 130 from chemicals and for preventing the liquid crystal panel 130 from being scratched. The transparent film 110 should be formed of a material having high scratch resistance and chemical resistance. When the buffer layer 120 is not provided, the transparent film 110 may be formed of an elastic material to perform a buffer function.

Next, a liquid crystal display device according to a fifth exemplary embodiment of the invention will be described with reference to FIG. 6. FIG. 6 is a cross-sectional view illustrating a liquid crystal display device 20 according to the fifth exemplary embodiment of the invention. The liquid crystal display device 20 according to the fifth exemplary embodiment of the invention is similar to the liquid crystal display device 10 (see FIG. 1A) according to the first exemplary embodiment except that the present exemplary embodiment further includes a second liquid crystal panel 230′. Thus, in the present embodiment, the same components as those in the first embodiment will not be described for the purpose of simplicity of explanation.

Referring to FIG. 6, the liquid crystal display device 20 includes a liquid crystal panel module 250 composed of a first liquid crystal panel 230, a first backlight unit 240, a second liquid crystal panel 230′, and a second backlight unit 240′.

The first liquid crystal panel 230 includes a first substrate 231 having a thin film transistor array thereon, a second substrate 233 having a color filter layer, and a liquid crystal layer 232 interposed between the first and second substrates 231 and 233. First and second polarizing plates 234 and 235 are provided on the outer surfaces of the first liquid crystal panel 230. The backlight unit 240 is arranged below the first substrate 231, and includes, for example, an optical sheet 241, an optical waveguide 242, a lamp 243, and a reflective plate 244. Similar to the first substrate 231, the second liquid crystal panel 230′ includes a first substrate 231′ having a thin film transistor array thereon, a second substrate 233′ having a color filter layer, and a liquid crystal layer 232′ interposed between the first and second substrates 231′ and 233′. First and second polarizing plates 234′ and 235′ are provided on the outer surfaces of the second liquid crystal panel 230′. The backlight unit 240′ is arranged below the first substrate 231′, and includes, for example, an optical sheet 241′, an optical waveguide 242′, a lamp 243′, and a reflective plate 244′. In the liquid crystal panel module 250, the first substrates 231 and 231′ of the first and second liquid crystal panels 230 and 230′ are arranged opposite to each other. That is, image display surfaces are arranged opposite to each other such that images can be displayed on both surfaces of the liquid crystal panel module 250.

Transparent films 210 and 210′ are formed on the second substrates 233 and 233′ of the first and second liquid crystal panels 230 and 230′ in the liquid crystal panel module 250 to protect the first and second liquid crystal panels 230 and 230′, respectively. In addition, buffer layers 220 and 220′ are respectively formed below the transparent films 210 and 210′ to fix the transparent films 210 and 210′ to the second substrates 233 and 233′ of the first and second liquid crystal panels 230 and 230′ and to absorb an external impact.

As described above, in the liquid crystal display device according to the present exemplary embodiment of the invention, the transparent films made of a light-weight material and having high impact resistance are respectively provided on both image display surfaces of the liquid crystal panel module, with the buffer layers having an adhesive function and a buffer function interposed therebetween. Thus, with the present exemplary embodiment, a liquid crystal display device which is both thinner and lighter in comparision to conventional liquid crystal display devices may be obtained.

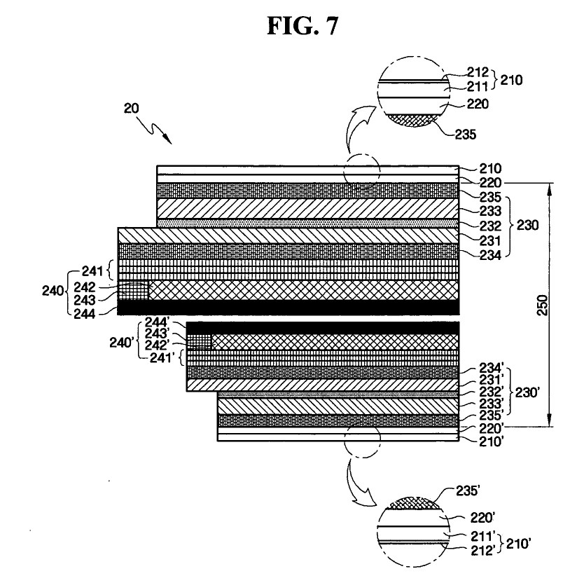

Next, a liquid crystal display device according to a sixth exemplary embodiment of the invention will be described with reference to FIG. 7. FIG. 7 is a cross-sectional view illustrating a liquid crystal display device 20 according to the sixth exemplary embodiment of the invention. The liquid crystal display device 20 according to the sixth exemplary embodiment of the invention is similar to the liquid crystal display device 20 according to the fifth exemplary embodiment shown in FIG. 6 except that transparent films 210 and 210′ in the present exemplary embodiment further include hard coating layers 212 and 212′, respectively. Thus, in the present embodiment, a description of components other than the transparent films 210 and 210′ will be omitted for the purpose of simplicity of explanation.

Referring to FIG. 7, the transparent films 210 and 210′ of the liquid crystal display device 20 protect first and second liquid crystal panels 230 and 230′ from chemicals and prevent the first and second liquid crystal panels 230 and 230′ from being scratched. The transparent films 210 and 210′ should be formed of a material having high scratch resistance and chemical resistance. The transparent films 210 and 210′ should have sufficient transparency, for example a transmittance of at least about 90%, such that a viewer may sufficiently view images displayed by the first and second liquid crystal panels 230 and 230′. Therefore, the transparent films 210 and 210′ are formed in laminated structures of polymer films 211 and 211′ satisfying the above-mentioned characteristics and the hard coating layers 212 and 212′ are formed on the polymer films 211 and 211′, respectively. The transparent films 210 and 210′ are formed on the second substrates 233 and 233′ of the first and second liquid crystal panels 230 and 230′ of the liquid crystal panel module 250, respectively.

As described above, in the liquid crystal display device 20 according to the sixth exemplary embodiment of the invention, the transparent films 210 and 210′ formed on the first and second liquid crystal panels 230 and 230′ include the hard coating layers 212 and 212′ as well as the polymer films 211 and 211′, and thus the first and second liquid crystal panels 230 and 230′ may be protected from scratches and chemicals.

Next, a liquid crystal display device according to a seventh exemplary embodiment of the invention will be described below with reference to FIGS. 3, 4 and 6. The liquid crystal display device 20 according to the seventh exemplary embodiment of the invention is similar to the liquid crystal display device 20 according to the sixth exemplary embodiment shown in FIG. 6 except that in the present exemplary embodiment, each of the transparent films 210 and 210′ are composed of a transmissive portion 111 which transmits light or each of the transparent films 210 and 210′ are composed of the transmissive portion 111 and a light-shielding portion 112 which does not transmit light. Therefore, in the present embodiment, a description of components other than the transparent films 210 and 210′ will be omitted for the purpose of simplicity of explanation.

Referring to FIGS. 3 and 4, each of the transparent films 210 and 210′ of the liquid crystal display device 20 according to the present exemplary embodiment of the invention may be composed of the transmissive portion 111 which transmits light through the entire surface thereof (as shown in FIG. 3), or each of the transparent films 210 and 210′ may be composed of the transmissive portion 111 which transmits light and the light-shielding portion 112 which does not transmit light( as shown in FIG. 4).

Buffer layers 220 and 220′ are formed below the transparent films 210 and 210′, respectively, and function to absorb an external impact and to fix the transparent films 210 and 210′ to the surfaces of liquid crystal panels 230 and 230′. The buffer layers 220 and 220′ should be formed of a material which is not significantly affected by temperature to provide sufficient buffer characteristics. For example, when the buffer layers 220 and 220′ are formed of a material having a high degree of hardness at a low temperature, the buffer layers 220 and 220′ may become damaged and thus may not sufficiently perform the function of absorbing an external impact. In addition, the buffer layers 220 and 220′ should have sufficient transparency such that a viewer is able to sufficiently view images displayed by the liquid crystal panels 230 and 230′.

Meanwhile, the buffer layers 220 and 220′ may be omitted, and the transparent films 210 and 210′ may be formed of an elastic material. In this case, the transparent films 210 and 210′ come into a direct contact with the liquid crystal panels 230 and 230′, respectively. At that time, it is preferable to deflate spaces between the transparent films 210 and 210′ and the liquid crystal panels 230 and 230′. Therefore, contact surfaces of the transparent films 210 and 210′ and the liquid crystal panels 230 and 230′ are electrified with reverse polarities, that is, negative and positive polarities, by static electricity, which enables the transparent films 210 and 210′ and the liquid crystal panels 230 and 230′ to be respectively bonded to each other by electrostatic attraction.

As described above, according to this exemplary embodiment of the invention, a thin and lightweight liquid crystal display device having high resistance to an external impact may be obtained.

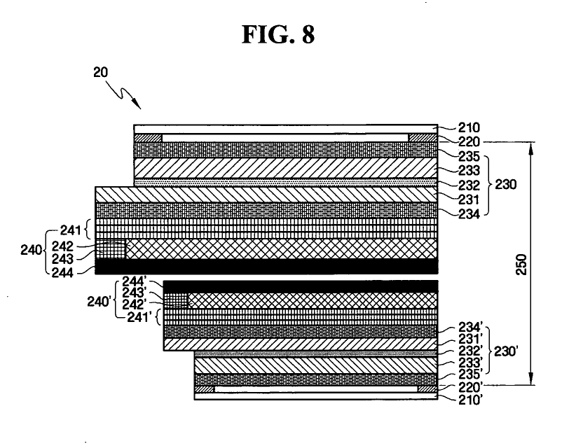

Next, a liquid crystal display device according to an eighth exemplary embodiment of the invention will be described below with reference to FIG. 8. FIG. 8 is a cross-sectional view illustrating a liquid crystal display device 20 according to the eighth exemplary embodiment of the invention. The liquid crystal display device 20 according to the present exemplary embodiment of the invention is similar to the liquid crystal display device 20 according to the fifth exemplary embodiment shown in FIG. 6 except that in the present exemplary embodiment the buffer layers 220 and 220′ are formed below parts of transparent films 210 and 210′, respectively. Thus, in the present exemplary embodiment, a description of components other than the buffer layers 220 and 220′ will be omitted for the purpose of simplicity of explanation.

Referring to FIG. 8, when each of the transparent films 210 and 220′ is composed of a transmissive portion 111, each of the buffer layers 220 and 220′ is formed below a part of the transmissive portion 111.

As shown in FIG. 8, when each of the transparent films 210 and 210′ is composed of the transmissive portion 111 and a light-shielding portion 112, the buffer layers 220 and 220′ may be formed below parts of the transmissive portions 111 or the light-shielding portions 112 of the transparent films 210 and 210′, respectively. Alternatively, the buffer layers 220 and 220′ may be formed below parts of the transmissive portions 111 and parts of the light-shielding portions of the transparent films 210 and 210′.

In this case, materials other than the buffer layers, such as, for example, an air layer, may be provided in spaces between the transparent films 210 and 210′ and the second substrates 233 and 233′ of the liquid crystal panels 230 and 230′ where the buffer layers 220 and 220′ are not formed, respectively.

Moroever, the transparent films 210 and 210′ may be directly bonded to the liquid crystal panels 230 and 230′ without the buffer layers 220 and 220′ interposed therebetween, respectively.

The transparent films 210 and 210′ serve as layers for protecting the liquid crystal panels 230 and 230′ from chemicals and for preventing the liquid crystal panels 230 and 230′ from being scratched. The transparent films 210 and 210′ should be formed of a material having high scratch resistance and chemical resistance. When the buffer layers 220 and 220′ are not provided, the transparent films 210 and 210′ may be formed of an elastic material to perform a buffer function.

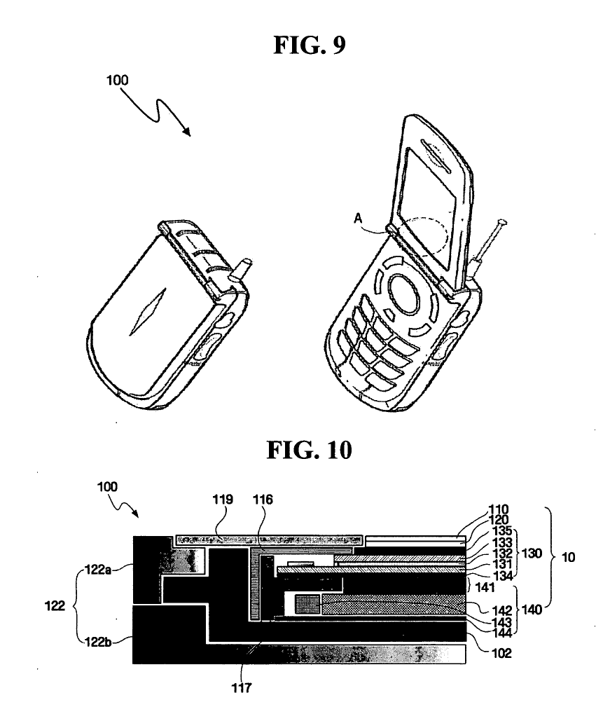

Next, a portable display apparatus according to a ninth exemplary embodiment of the invention will be described below with reference to FIGS. 9 and 10. FIG. 9 is a perspective view illustrating the portable display apparatus according to the ninth exemplary embodiment of the invention, and FIG. 10 is a longitudinal cross-sectional view of a region A shown in FIG. 9.

A portable display apparatus 100 shown in FIG. 9 is a folder type. The folded state of the portable display apparatus 100 is shown on the left side of FIG. 9, and the unfolded state thereof is shown on the right side of FIG. 9. The folder-type portable display apparatus 100 is shown in FIG. 9, but the exemplary embodiments of the invention are not limited thereto.

FIG. 10 is a longitudinal cross-sectional view of the region A of the portable display apparatus 100 shown in FIG. 9. The portable display apparatus 100 may be provided with, for example, any of the liquid crystal display devices 10 shown in FIGS. 1 to 5. The liquid crystal display device 10 includes, for example, the transparent film 110, the buffer layer 120 (which may be omitted), the liquid crystal panel 130, and the backlight unit 140.

The portable display apparatus 100 includes first to third frame 102, 117, and 116 for supporting the liquid crystal display device 10 and first to third protective cases 122a, 122b, and 119 for housing these frames.

As the liquid crystal display device 10 and components thereof have already been described above, a detailed description thereof will be omitted in this exemplary embodiment for the purpose of simplicity. Therefore, components other than the above-mentioned components and the housing structure of the liquid crystal display device 10 in the portable display apparatus 100 will be described in detail below.

The liquid crystal display device 10, the second frame 117, and the third frame 116 are encased in the first frame 102. For example, the backlight unit 140 including the optical sheet 141, the light guide panel 142, the light source 143, and the reflective sheet 144 are housed in the first frame 102. The second frame 117 is provided to fix the backlight unit 140 including the optical sheet 141, the light guide panel 142, the light source 143, and the reflective sheet 144. The second frame 117 has an opening in the center thereof, and the optical sheet 141 is positioned at the opening. In this way, light emitted from the light source 143 can pass through the opening. Meanwhile, the liquid crystal display device 10 is provided on the second frame 117.

The third frame 116 fixes the liquid crystal display device 10 or 20.

The buffer layer 120 may be formed on the liquid crystal panel 130. In this case, the buffer layer 120 may be formed on the entire upper surface of the liquid crystal panel as in the liquid crystal display device according to the first exemplary embodiment, or it may be formed on a portion of the upper surface of the liquid crystal display device as in the fourth exemplary embodiment of the invention. As shown in FIG. 1B, the buffer layer 120 may be formed in a multi-layer structure of a first adhesive layer 122 adhered to the transparent film 110, a second adhesive layer 123 adhered to the liquid crystal panel 130, and a cushion layer 121 interposed between the first adhesive layer 122 and the second adhesive layer 123.

Further, the transparent film 110 having a front surface exposed to the outside is formed on the buffer layer 120. In this case, the transparent film 110 may be formed of a single polymer film, as shown in FIG. 1, or it may be formed of the polymer film 111 and the hard coating layer 112, as shown in FIG. 2. In addition, as shown in FIGS. 3 and 4, the entire surface of the transparent film 110 is composed of the transmissive portion 111, or it may be composed of the transmissive portion 111 and the light-shielding portion 112.

The liquid crystal display device 10 including the transparent film and the buffer layer, the first frame 102, the second frame 117, and the third frame 116 are housed in the first protective case 122a, the second protective case 122b and the third protective case 119. The first protective case 122a has an opening formed therein such that an image region of the liquid crystal panel 130 is exposed.

Meanwhile, the third protective case 119 covers the first frame 102 and the third frame 116 exposed through the opening of the first protective case 112a to protect the portable display apparatus. However, the third protective case 119 does not cover any part of the transparent film 110 so that the entire surface of the transparent film 110 is exposed to the outside.

In a conventional display apparatus, a transparent protective glass for protecting the liquid crystal display device is adhered to a portion where the third protective case 119 is formed by a double-sided tape. However, in the portable display apparatus 100 according to this exemplary embodiment of the invention, instead of using the transparent protective glass, the third protective case 119 is provided to protect the first frame 102 and the third frame 116 exposed through the opening of the first protective case 122a. Alternatively, the third protective case 119 may be integrally formed with the first protective case 122a.

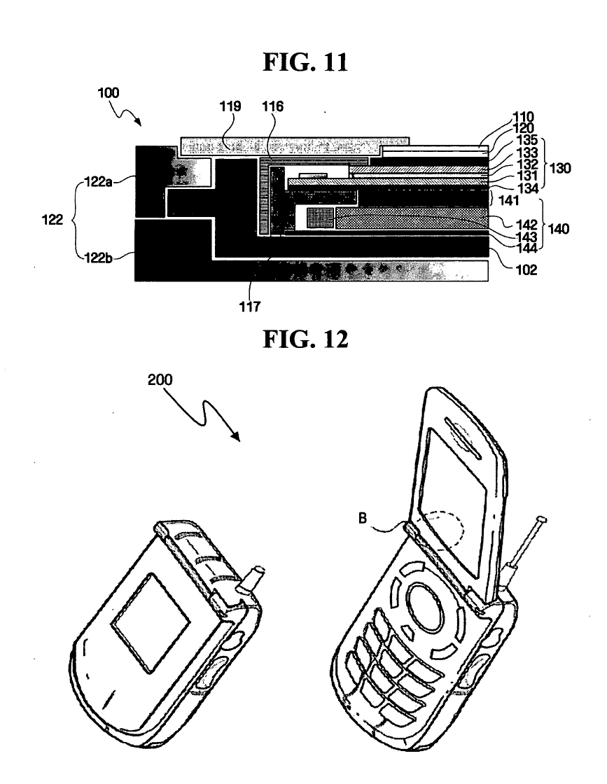

Next, a portable display apparatus according to a tenth exemplary embodiment of the invention will be described below with reference to FIG. 11. FIG. 11 is a longitudinal cross-sectional view of the region A shown in FIG. 9.

The portable display apparatus according to the tenth exemplary embodiment of the invention is similar to the portable display apparatus according to the ninth exemplary embodiment except that, in the present exemplary embodiment, a third protective case 119 covers a portion of the transparent film 110. Therefore, a description of the same components as those in the ninth embodiment will be omitted for the purpose of simplicity of explanation.

A portable display apparatus 100 according to the present exemplary embodiment may be provided with, for example, any of the liquid crystal display devices 10 shown in FIGS. 1 to 5. The liquid crystal display device 10 includes, for example, the transparent film 110, the buffer layer 120 (which may be omitted), the liquid crystal panel 130, and the backlight unit 140.

The portable display apparatus 100 includes first to third frames 102, 117, and 116 for supporting the liquid crystal display device 10 and first to third protective cases 122a, 122b, and 119 for housing these frames. In this case, a portion of the transparent film 110 is covered with the third protective case 119.

In the portable display apparatus 100 according to the tenth exemplary embodiment of the invention shown in FIG. 11, the third protective case 119 covers a portion of the transparent film 110. However, the exemplary embodiments of the invention are not limited to this structure.

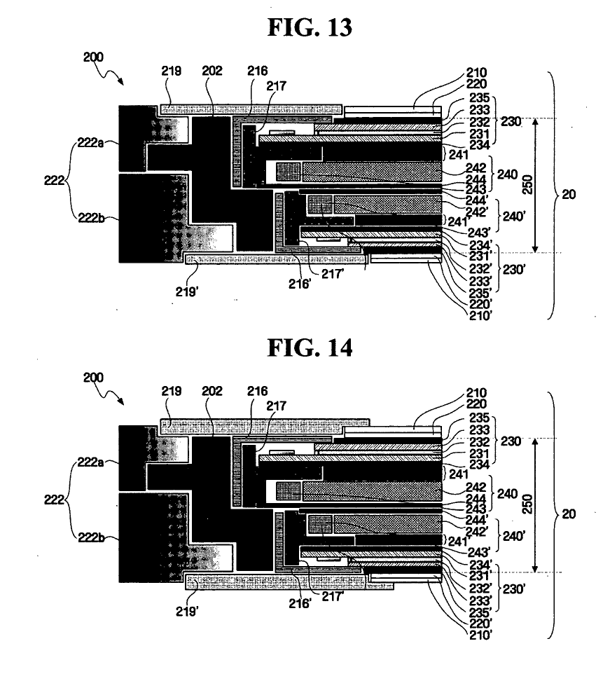

Next, a portable display apparatus according to an eleventh exemplary embodiment of the invention will be described below with reference to FIGS. 12 and 13. FIG. 12 is a perspective view illustrating the portable display apparatus according to the eleventh exemplary embodiment of the invention, and FIG. 13 is a longitudinal cross-sectional view of a region B shown in FIG. 12.

A portable display apparatus 200 shown in FIG. 12 is a folder type. The folded state of the portable display apparatus 200 is shown on the left side of FIG. 12, and the unfolded state thereof is shown on the right side of FIG. 12. The folder-type portable display apparatus 200 is shown in FIG. 12, but the exemplary embodiments of the invention are not limited thereto. As shown in FIG. 12, the portable display apparatus 200 includes a first liquid crystal panel 230 and a second liquid crystal panel 230′.

FIG. 13 is a longitudinal cross-sectional view of the region B of the portable display apparatus 200 shown in FIG. 12. The portable display apparatus 200 may be provided with any of the liquid crystal display devices 20 shown in FIGS. 6 to 8. The liquid crystal display device 20 includes, for example, the first liquid crystal panel 230 and the second liquid crystal panel 230′. The transparent films 210 and 210′ are respectively formed on the second polarizing plates 235 and 235′ provided on the second substrates 233 and 233′ of the first and second liquid crystal panels 230 and 230′. Since components other than the above-mentioned components have already been described above, a detailed description thereof will be omitted.

The portable display apparatus 200 includes a first frame 202, second frames 217 and 217′, and third frames 216 and 216′ for supporting the liquid crystal display device 20 and further includes a first protective case 222a, a second protective case 222b, and third protective cases 219 and 219′ for housing these frames. The frames 202, 216, 216′, 217, and 217′ for supporting the liquid crystal display device 20 and the protective cases 222a, 222b, 219, and 219′ are substantially similar to those of the portable display apparatus 100 according to the ninth exemplary embodiment (see FIG. 10) in structure, and thus a detailed description thereof will be omitted.

However, the first frame 202 is used not only to support and fix the first liquid crystal panel 230 and the first backlight 240 but also to fix the second liquid crystal panel 230′ and the second backlight unit 240′. The first protective case 222a and the second protective case 222b have openings at positions corresponding to image display regions of the first and second liquid crystal panels 230 and 230′, respectively. In addition, the third protective cases 219 and 219′ are formed in the opening regions to protect the frames 202, 217, 202′, and 217′. The third protective cases 219 and 219′ may be integrally formed with the first and second protective cases 222a and 222b, respectively.

As described above, in the portable display apparatus 200 having the above-mentioned structure, the transparent films 210 and 210′ are formed on the second polarizing plates 235 and 235′ of the first and second panels 230 and 230′, respectively. Since the structures of the polarizing plates 235 and 235′ have already been described above, a detailed description thereof will be omitted herein.

Next, a portable display apparatus according to a twelfth exemplary embodiment of the invention will be described below with reference to FIG. 14. FIG. 14 is a longitudinal cross-sectional view of the region A shown in FIG. 12.

The structure of the portable display apparatus according to the twelfth exemplary embodiment of the invention is similar to that of the portable display apparatus according to the eleventh exemplary embodiment except that in the present exemplary embodiment, third protective cases 219 and 219′ cover portions of transparent films 210 and 210′, respectively. Therefore, in the present exemplary embodiment, a description of the same components as those in the eleventh exemplary embodiment will be omitted for the purpose of simplicity of explanation.

A portable display apparatus 200 according to the present exemplary embodiment includes the liquid crystal display devices 20 shown in FIG. 13. The liquid crystal display device 20 includes, for example, the transparent films 210 and 210′, the buffer layers 220 and 220′ (which may be omitted), the liquid crystal panels 230 and 230′, and the backlight units 240 and 240′.

The portable display apparatus 200 includes a first frame 202, second frames 217 and 217′, and third frames 216 and 216′ for supporting the liquid crystal display device 20 and further includes a first protective case 222a, a second protective case 222b, and third protective cases 219 and 219′ for housing these frames. In this case, portions of the transparent films 210 and 210′ are covered with the third protective cases 219 and 219′, respectively.

In the portable display apparatus 200 according to the twelfth exemplary embodiment of the invention shown in FIG. 14, the third protective cases 219 and 219′ cover portions of the transparent films 210 and 210′, respectively, but the exemplary embodiments of the invention are not limited to this structure.

As mentioned above, according to the exemplary embodiments of the invention, a display device which is both thin and lightweight and a portable display apparatus including the same may be obtained.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A display device comprising:
a display panel having a first substrate and a second substrate opposite to the first substrate;
a transparent film formed on the second substrate; and
a buffer layer formed between the transparent film and the second substrate.

2. The display device of claim 1,
wherein the buffer layer is formed on a portion of the second substrate.

3. The display device of claim 1,
wherein the transparent film has a light-shielding region.

4. The display device of claim 1,
wherein the buffer layer has an adhesive characteristic.

5. The display device of claim 1,
wherein the buffer layer has a transmittance of at least about 60%.

6. The display device of claim 1,
wherein the buffer layer is formed of a material comprising one of a silicon-based resin or an acryl-based resin.

7. The display device of claim 1,
wherein the transparent film is a polymer film having a transmittance of at least about 90%.

8. The display device of claim 7,
wherein the polymer film is formed of a material comprising a polyethylene terephthalate, a polycarbonate, or a polymethylmethacrylate.

9. The display device of claim 7,
wherein the transparent film has a hard coating layer formed on the polymer film.

10. The display device of claim 9,
wherein the hard coating layer is formed of a photosensitive resin.

11. The display device of claim 1,
wherein the buffer layer has at least two distinct layers.

12. The display device of claim 11,
wherein the buffer layer comprises:
a first adhesive layer adhered to the transparent film;
a second adhesive layer adhered to the display panel; and
a cushion layer interposed between the first adhesive layer and the second adhesive layer.

13. A display device comprising:
a liquid crystal panel module having first and second liquid crystal panels each provided with a first substrate, a second substrate, and a liquid crystal layer interposed between the first substrate and the second substrate, the first substrate of each of the first and second liquid crystal panels being disposed opposite to each other;
a transparent film formed on the second substrate of each of the first and second liquid crystal panels of the liquid crystal panel module; and
a buffer layer formed between the transparent film and the second substrate of each of the first and second liquid crystal panels.

14. A portable display apparatus comprising:
a liquid crystal display device having a liquid crystal panel provided with a first substrate, a second substrate, and a liquid crystal layer interposed between the first substrate and the second substrate;
a transparent film formed on the second substrate to protect the liquid crystal panel;
a frame supporting the liquid crystal display device housed therein; and
a case housing the frame.

15. The portable display apparatus of claim 14, further comprising:
a buffer layer formed between the transparent film and the second substrate.

16. The portable display apparatus of claim 14,
wherein the case covers at least a portion of an upper surface of the transparent film.

17. A portable display apparatus comprising:
a liquid crystal panel module having first and second liquid crystal panels each provided with a first substrate, a second substrate, and a liquid crystal layer interposed between the first substrate and the second substrate, the first substrate of each of the first and second liquid crystal panels being disposed opposite to each other;
a transparent film formed on the second substrate of each of the first and second liquid crystal panels of the liquid crystal panel module;
a frame supporting the liquid crystal panel module housed therein; and
a case housing the frame,

18. The portable display apparatus of claim 17, further comprising:
a buffer layer formed between the transparent film and the second substrate of each of the first and second liquid crystal panels of the liquid crystal panel module.

19. The portable display apparatus of claim 17,
wherein the case covers at least a portion of an upper surface of each of the transparent films.

20. A display device comprising:
a display panel;
a transparent film formed on the display panel; and
an adhesive buffer layer, formed between the display panel and the transparent film, and having a transmittance of at least about 60%.

21. A display device comprising:
a display panel;
a transparent film formed on the display panel; and
a buffer layer, formed between the display panel and the transparent film, and comprising
at least two distinct layers.
